(19) United States
(12) Patent Application Publication
(10) Pub. No.: US 2006/0222898 A1
(43) Pub. Date: Oct. 5, 2006

(54) Magnetic recording medium and production method therefor

(75) Inventor: Shigeru Ichihara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/384,300

(22) Filed: Mar. 21, 2006

(30) Foreign Application Priority Data
Apr. 5, 2005 (JP) 2005-108667

(51) Int. Cl. G11B 5/64; B05D 5/12

(52) U.S. Cl. 428/826; 428/836.2; 427/127

(57) ABSTRACT

An object is to provide a magnetic recording medium with a recording region having little magnetic property degradation, and to provide a production method therefor. This method for producing the magnetic recording medium comprises the steps of preparing a structure having a plurality of magnetic material regions 11 with a columnar structure made of a magnetic material separated by non-magnetic material regions 12 made of a non-magnetic material; forming a mask pattern 13 on a portion to be a recording region in the structure; and removing the magnetic material in a plurality of the magnetic material regions 11 in the regions on which the mask pattern 13 is not formed, in the structure, or transforming magnetic properties of the magnetic material, to arrange separation regions which magnetically separate adjacent recording regions.

### BACKGROUND OF THE INVENTION

1. Field of the Invention

The present invention relates to a high-density magnetic recording technology, particularly relates to a magnetic recording medium with a reduced side cross talk and improved tracking precision, and relates to a production method therefor.

2. Related Background Art

As an amount of information has dramatically increased in recent years, an information recording technology such as a magnetic recording device is required to greatly increase the recording capacity. In such a situation, a magnetic recording medium such as a hard disk (HDD) needs to improve not only a linear recording density but also a track recording density, in order to improve surface recording density.

If a track width is narrowed in order to increase the track recording density, blurring in a track edge due to a magnetic field spatially radiated from a tip of a magnetic head, and magnetic interference (cross talk) between adjacent recording tracks occur. Thereby, the track width varies, and as a result, a regenerative signal is degraded by increasing medium noises.

Against such a problem, a discrete track medium has been proposed which magnetically separates recording tracks to be recording regions. The discrete track medium can effectively inhibit the mutual cross talk between the tracks, even when a space between recording tracks is thoroughly narrowed, and accordingly is expected to have a higher recording density. The discrete medium of this type also has an advantage of making a magnetic head precisely access the objective magnetic track.

Methods for producing various types of discrete track media have been proposed, and as a method of not requiring fine processing for a medium surface, a method has been proposed which chemically demagnetizes a magnetic layer to become a region prepared between tracks. For instance, there are a method for implanting a nitrogen ion into the magnetic layer for demagnetization, and a method for halogenating the magnetic layer for demagnetization (U.S. Patent Application No. 20020142192).

However, there is apprehension that the above described conventional technique may degrade a magnetic material of adjacent recording track regions, when demagnetizing the magnetic layer of the region between the tracks by using a reactive gas or implanting ions, so that the further improvement has been demanded to the conventional technique.

For this reason, the present invention has been thought of in view of such problems, and has its object to provide a magnetic recording medium having inhibited the magnetism of a recording track region from being degraded, and to provide a production method therefor.

### SUMMARY OF THE INVENTION

According to an aspect of the present invention, there is provided a method for producing a magnetic recording medium comprising:

a first step of preparing a structure having a plurality of first regions with a columnar structure made of a magnetic material separated by second regions made of a non-magnetic material;

a second step of forming a mask on a part to be a recording region in the structure; and

a third step of removing the magnetic material in a plurality of the first regions in the regions on which the mask is not formed, in the structure, or transforming magnetic properties of the magnetic material.

In the third step, the magnetic material is preferably removed or the magnetic properties of the magnetic material are transformed by exposing the structure to a reactive gas or a reactive solution.

The magnetic material is preferably CoCrPt and the non-magnetic material is SiO₂.

According to another aspect of the present invention, there is provided a magnetic recording medium provided with recording regions, and separation regions which magnetically separate the adjacent recording regions, wherein

the recording region is composed of a plurality of first regions with a columnar structure made of a magnetic material, and a plurality of second regions which separate the first regions and are made of a non-magnetic material,

the separation region is composed of a third region which has a plurality of columnar pores and is made of the non-magnetic material, and

the columnar structure penetrates the recording region in the thickness direction. The magnetic material is preferably CoCrPt and the non-magnetic material is SiO₂.

The present invention can provide a magnetic recording medium which really has a reduced side cross talk and an improved tracking precision while inhibiting the magnetism of a recording region from being degraded, and which has consequently an improved surface recording density.

### BRIEF DESCRIPTION OF THE DRAWINGS

FIGS. 1A, 1B, 1C, 1D, 1E and 1F are schematic views showing examples of a production method according to the present invention and of a magnetic recording medium; and

FIGS. 2A and 2B are schematic block diagrams of a structure having fine pores.

### DETAILED DESCRIPTION OF THE PREFERRED EMBODIMENT

Embodiments according to the present invention will be now described below in detail with reference to the drawings.

<Method for Producing Magnetic Recording Medium According to the Present Invention>

A method for producing a magnetic recording medium according to the present invention will be described in detail below referring to the drawings.

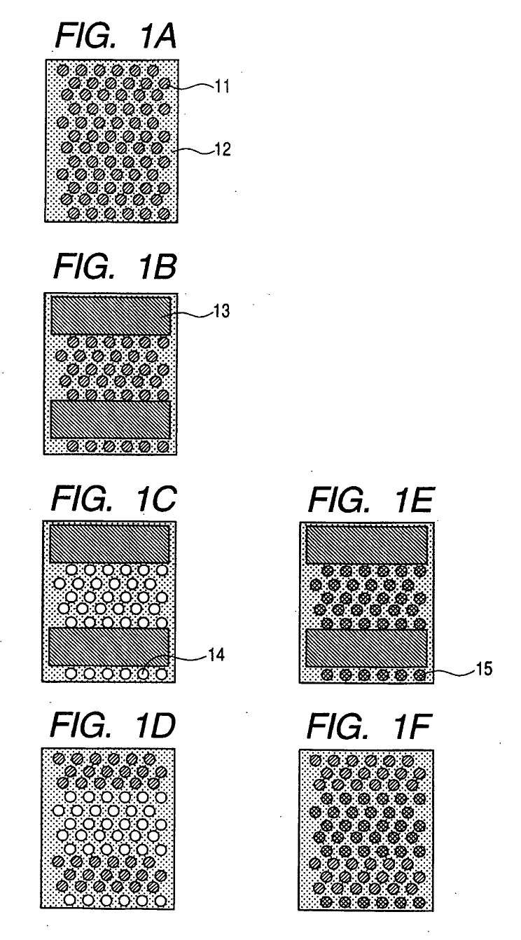

FIGS. 1A to 1F show schematic views of a production method therefor.

(1) Step of Preparing Structure Having Magnetic Material Region with Columnar Structure Separated by Non-magnetic Material Region

FIG. 1A shows a structure having a magnetic material region 11 of a columnar structure separated by a non-magnetic material region 12. As methods of preparing the structure, there are 1) a production method by using a dry process, and 2) a production method using a nano-hole structure.

1) Production Method by Using Dry Process

A dry process is a production process using a technique such as a PVD (physical vapor deposition) technique and a CVD (chemical vapor deposition) technique. Here, it is particularly preferable to use a magnetron sputtering technique. Then, with the use of the magnetron sputtering technique, a structure having a magnetic material region of a columnar structure separated by a non-magnetic material region is prepared, through sputtering simultaneously the targets made of a magnetic material and a non-magnetic material. Generally, a medium having a magnetic material dispersed in a non-magnetic material is called a granular medium, and in the granular medium, magnetic particles are approximately completely magnetically insulated by the non-magnetic material existing between the particles, and exchange coupling is reduced between the magnetic particles to make a magnetic cluster fine. As a result, magnetic interference between adjacent recording bits is reduced and medium noises are reduced, which contributes to the improvement of a linear recording density.

(Non-patent document:

S. Oikawa, A. Takeo, T. Hikosaka, and Y. Tanaka, IEEE Trans. Magn., vol. 36, pp. 2393-2395, 2000;

T. Oikawa, M. Nakamura, H. Uwazumi, T. Shimatsu, H. Muraoka, and Y. Nakamura, ″IEEE Trans. Magn., vol. 38, pp. 1976-1978, 2002).

Particularly, in a granular medium such as CoCrPt—SiO₂ that is a typical example in which a magnetic material and a non-magnetic material are further separated, it is confirmed that a magnetic material portion becomes a columnar structure. In the present invention, such a medium having a magnetic material in a columnar structure is prepared, and a discrete track medium is produced through the steps described below.

A magnetic material according to the present invention has preferably a high saturation magnetization Ms and a high magnetic anisotropy coefficient Ku, and has perpendicular magnetic anisotropy. Specifically, the magnetic material is a hard magnetic material mainly containing Co and Fe, which includes a Co base alloy, for instance, having one or more elements of Fe, Cr, Pt, Ta, Nb, Pd, B, Si, Ti, V, Ru and Rh added to Co with an hcp structure. It is also preferable that the magnetic material is an L1₀ or L1₂ ordered alloy or the like mainly containing FePt, FePd, CoPt and/or CoPd with high magnetic anisotropy, which receive attention as a next-generation magnetic recording material.

On the other hand, a non-magnetic material for separating a magnetic material includes an oxide such as SiO₂, Al₂0₃, TiO₂, MgO, TaO, ZnO and B₂0₃; a nitride such as SiNx, AlN and TiN; a carbide such as TiC; a boride such as BN; and even other inorganic substances.

2) Production Method by Using Nano-hole Structure

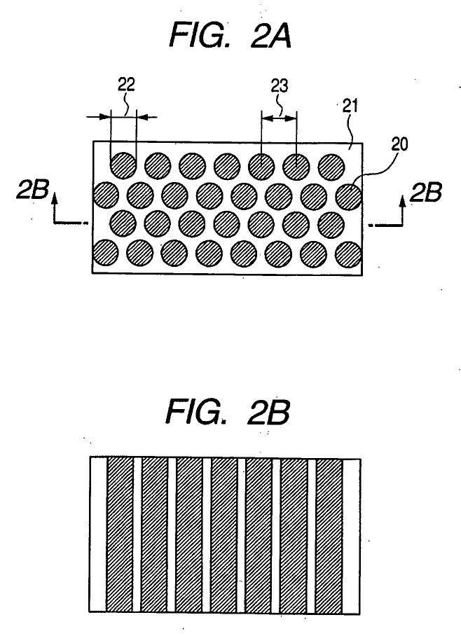

FIGS. 2A and 2B are a plan view and a sectional view diagrammatically showing a structure having pores. There is a method for preparing the structure having pores to be a host space of a recording layer as shown in FIGS. 2A and 2B, by anodizing aluminum. There is also a method for forming the pores by using an AlSi (or AlGe or AlSiGe) structure having circular columnar aluminum surrounded by silicon (or germanium or silicon germanium) . They will be hereafter described in detail. A structure such as block copolymer may also be used.

At first, characteristics of a structure (alumina nano-hole) having pores provided by anodic oxidation of aluminum will be described.

Pores 20 are formed in an aluminum film arranged on a substrate through a self-assembling way by immersing a part in which the pores are to be formed, in an aqueous solution of phosphoric acid, oxalic acid, sulfuric acid or the like, setting the aluminum film as an anode, and applying voltage on it. A space 23 between the pores formed then is determined by the applied voltage, and as the relation, the expression of 2.5×voltage [V] (nm) is known.

When preparing a discrete track structure shown by the present invention, it is preferable to use a structure in which a space between pores is narrow and the diameter of a nano-hole is 20 nm or less and preferably is about 10 nm.

A characteristic is provided that in the process for preparing alumina nano-holes, forming regular dimples on the surface of an aluminum film allows the creation of regular pores from the dimples in a honeycomb or square shape. The method has the large possibility of forming particularly a patterned medium, which is characteristic.

A specific example of the above described structure having the fine pores formed by anodizing aluminum is described in Japanese Patent Application Laid-Open No. H11-200090.

In the next place, a structure will be described which consists of a columnar aluminum portion containing aluminum standing perpendicularly to a substrate, and a part made from Si, Ge or SiGe arranged so as to surround a side face of the columnar aluminum portion. Here, Si is used as an example, but Ge or SiGe produces a similar result. These structures are distinguished by a diameter 22 of pores and a space 23 between the pores in FIGS. 2A and 2B.

It is a feature of a structure that a circular columnar Al portion stands straight perpendicularly to a substrate, and that a Si part is arranged as a base metal 21 so as to surround a side face of the column. Here, the Al portion is slightly contaminated with Si, and the Si part with Al. In order to form the structure, it is preferable to form a film with the use of Al and Si in a non-equilibrium state. It is another feature of the structure that the columnar Al portion stands straight perpendicularly to a substrate, and that the only columnar Al portion can be dissolved and removed, by immersing the substrate in such an acid solution or an alkaline solution as to dissolve the columnar Al portion. For the acid or the alkali, a plurality of acids like phosphoric acid and sulfuric acid, or alkalis like ammonia water are applicable.

A columnar Al portion can also be removed by anodizing an AlSi structure in an aqueous solution of sulfuric acid or the like. When the AlSi structure is anodized, the Si part is oxidized into (AlₓSi₁₋ₓ)_{z}O_{1-z}. Here, it is possible to increase the separation degree of Al and Si, so that a range of x is in a range of 0<x<0.2, and is preferable in a range of 0<x<0.1. An oxidizing state varies with an etching period of time for removing Al and a type of an acid or a base, but a range of Z is 0.334<z<1, covering an unoxidized state. In the present invention, it is preferable to make Si into a more oxidized state. In order.to perform forceful oxidation, an anodic oxidation method can be used. The anodizing process is preferably finished in 30 to 60 seconds after a pore has arrived at an underlayer. Alternatively, the anodic oxidation may be continued until a current value in the anodic oxidation reaches the minimum value. The oxidation may also be performed by annealing in an oxygen atmosphere.

The AlSi structure from which Al has been removed has a structure consisting of pores having a diameter 22 of 1 to 15 nm and a space 23 between the pores in a range of 3 to 20 nm, depending on a composition of the AlSi structure. As described above, a wall surrounding the pore 20 is made of Si or silicon oxide, which depends on a means of removing an Al portion.

A specific example of the above described structure made from Si, Ge or SiGe is described in Japanese Patent Application Laid-Open No. 2004-237431.

A magnetic material can be filled in the above described nano-pores of the structure, by setting an underlayer of a pore bottom as an electrode, and using an electrodeposition technique. Particularly, by simultaneously depositing a magnetic metal such as Fe, Co and Ni and a noble metal such as Pt and Pd in the nano-pores, the filled magnetic material can have an L1₀ or L1₂ order composition represented by FePt and CoPt. It is also possible to fill a magnetic material such as a Co base alloy with an hcp structure and a material mainly made from Ni or Fe with an fcc structure.

As the above electrodeposition technique, a pulse plating technique of controlling a potential and a potential-applied period as needed as well as a normal electrolytic plating technique of continuously applying a constant electropotential can be used. Particularly, when the pulse plating technique is employed, it can increase the density of nuclei in plating, which effectively acts in plating to the pores.

(2) Mask-forming Step

A step of forming a mask pattern by using a resist is shown (in FIG. 1B) . The portion which has been covered with a mask pattern becomes a recording region of a magnetic recording medium, and the portion which has not been covered becomes a separation region for magnetically separating the recording regions. A mask pattern 13 is formed by using a photoresist in a general semiconductor process. Specifically, the photoresist, for instance, of a photosensitive material is formed by spin coating on the surface of a structure shown in FIG. 1A. Subsequently, the resist pattern is formed by the steps of exposing the photosensitive film to ultraviolet light, an electron beam, X-ray and the like, then developing it, and rinsing it. The resist pattern can also be formed into an imprint shape (resist pattern) by coating the resist, and imprinting the shape of a forming moldonto the surface while pressurizing the mold under heating. Furthermore, the resist pattern may be formed by electron beam lithography or the like.

A photosensitive material to be used here has sufficient resistance to an etching solution to be used in the step of etching a magnetic material, which will be described below. Specifically, the photosensitive material is required not to dissolve or exfoliate in the etching solution which is a reactive solution, and further is chemically stable to a reactive gas to be used for the magnetic material. Specifically, the photosensitive material includes a chemical sensitization type positive resist as a positive resist, and is preferably cured by using a UV cure technique or the like. The photosensitive material includes a chemical sensitization type negative resist, an isoprene-based resist, and a phenolic-based resist. The negative resist is also preferably cured by post-annealing or UV cure after having been developed. The positive and negative resists are not limited to the above described materials.

In order to prepare a discrete track medium, a concentric circular mask pattern needs to be formed. It is also possible to form the mask pattern for a servo pattern for positional information.

(3) Step of Removing Magnetic Material or Transforming the Magnetic Properties in Region Where Mask is Not Formed

A step of selectively removing a magnetic material with a columnar structure in a region where a mask is not formed is shown (in FIG. 1C). In the step, only the columnar magnetic material is selectively etched (as is shown by reference numeral 14 in FIG. 1C). Specifically, the columnar magnetic material portions selectively dissolve and are removed through a chemical reaction, while non-magnetic material portions surrounding the magnetic material do not. If an etching technique such as RIE (reactive ion etching) which causes physical shock is employed, it has a high possibility of destroying the non-magnetic material portion as well, and has difficulty in selectively etching only the magnetic material portion. Thus, wet etching with the use of various chemical solutions is suitable. The chemical solution needs to be selected in consideration of the magnetic material. For instance, when dissolving a metal contained in a magnetic material such as Co, Fe and Ni, a chemical solution to be used can be a strong base such as NaOH or a strong acid such as HCl and H₂SO₄. Furthermore, if necessary, such a chemical solution as to contain hydrogen peroxide water (H₂O₂) or the like having oxidizability can be employed. A noble metal such as Pt and Pd has comparatively high chemical resistance. It is possible to dissolve such a material by immersing it in a solution containing halogen, a halogenated salt and an organic solvent. For instance, it is possible to dissolve Pt by using a chemical solution containing iodine, cetylpyridinium iodide and benzene added thereto. It is possible to form a structure in which only the magnetic material portion is selectively removed as is shown FIG. 1C by using the chemical solution containing those types of appropriately combined reagents.

When a mask of FIG. 1C is removed, a magnetic material region covered with the mask becomes the region in which magnetic properties are not degraded or are inhibited from being degraded. Specifically, in a structure as is shown in FIG. 1C, such an etching is carried out as to be able to selectively remove only the magnetic material portions. Then, in a plurality of magnetic material regions 11 which are not masked, a perimeter of the magnetic material region 11 is surrounded by a non-magnetic material region 12, so that etching takes place substantially only in each magnetic material region. Accordingly, even in a border of a mask, the etching for the magnetic material region that is not covered with the mask does not affect the adjacent magnetic material region covered with a mask, because in the perimeter of the magnetic material region, there is the non-magnetic material region which covers the magnetic material region.

When etching a region with a chemical solution, it is possible for the chemical solution to increase its etchability by controlling its solution temperature or irradiating the region with light. The etchability can also be improved by electrolyzing a substrate so that the substrate can have a plus potential. When employing the heat, the irradiation with light and an electrolysis effect, attention has to be indispensably paid so that those means do not affect a magnetic material in the region covered with a resist, in other words, in a recording track portion.

On the other hand, it is also possible to form a discrete medium which uses a difference in magnetic properties, by only transforming the magnetic properties (FIG. 1E), without etching a magnetic material. The magnetic properties can be changed by the steps of: introducing a gas such as CF₄, CHF₃ and CH₂F₂ containing halogen as a reactive gas into a chamber having a plasma atmosphere to which high frequency voltage is applied; colliding with electrons accelerated in an electric field to the reactant gas to form chemically active radicals; introducing the magnetic material into the chamber in which such active radicals exist; and thereby chemically reacting the radicals with the magnetic material. As a result of having prepared samples before and after exposing them to the gas and having measured the MH loop of them with an AGM (Alternating Gradient Magnetometer), the sample after having been exposed to the gas showed obviously reduced residual magnetization, which proves that the magnetic properties degraded. The method of transforming a columnar magnetic material into a non-magnetic material is not limited to the above described method of halogenating the magnetic material, but also can include a method of implanting an oxygen ion or a nitrogen ion into the magnetic material. The magnetic material in the recording track part covered with a resist is surrounded by the region of the non-magnetic material such as an oxide. For this reason, in a border of a mask, the magnetic properties of the columnar magnetic material portion under the mask is inhibited from being transformed by activated ions or halogen radicals having reached a side face of the magnetic material. Therefore, it becomes possible to transform precisely only the columnar magnetic material portion which is not covered with the mask into a non magnetic material (as is shown by reference numeral 15 in FIG. 1E), and accordingly to form a desired discrete structure and a servo pattern.

A process is completed by removing a resist of a masked part (FIGS. 1D and 1F) as a final step. A portion which has been covered with a mask pattern becomes a recording region of a magnetic recording medium, and a portion which has not been covered becomes a separation region for magnetically separating the recording regions.

### EXAMPLE 1

A first embodiment according to the present invention will be described.

(1) Step of Preparing Structure Having Magnetic Material of Columnar Structure Separated by Non-magnetic Material

A backing soft magnetic layer, an intermediate layer and the like were formed on a substrate, and a recording layer formed of a CoCrPt—SiO₂ layer with a thickness of 20 nm was formed, in which a magnetic material CoCrPt was separated by a non-magnetic material SiO₂. Here, Ru was used for the intermediate layer. The CoCrPt—SiO₂ layer was formed by simultaneously sputtering a CoCrPt magnetic target and a SiO₂ non-magnetic target in a magnetron sputtering apparatus. As a result of having analyzed the chemical composition, it was confirmed that CoCrPt in a magnetic portion was (Co₉₀Cr₁₀)₇₅Pt₂₅ and Sio₂ was 11% by a ratio to CoCrPt. As a result of having observed the surface and the cross section of the above described recording layer made of the above described CoCrPt—SiO₂ with a TEM, it was confirmed that the portion of CoCrPt which is the magnetic material is completely separated by a non-magnetic material region mainly formed of non-magnetic SiO₂, and that the magnetic material has a columnar structure.

(2) Mask-forming Step

A resist pattern (mask pattern 13) as is shown in FIG. 1B was formed on a CoCrPt—SiO₂ layer by the steps of coating a chemical sensitization type negative resist into a thickness of about 1.0 μm by using a spin coating technique, exposing the resist at a time, and developing it. Thus formed resist was then cured through post annealing at 200° C. for 10 minutes, and further through UV cure treatment of irradiating the resist with ultraviolet light at 150° C. for five minutes.

(3) Step of Removing Magnetic Material in Region in which Mask is Not Formed or Transforming Magnetic Property

An etching solution (A) containing hydrogen peroxide water added to an NaOH aqueous solution having a pH 13 and an etching solution (B) of 60° C. containing iodine, cetylpyridinium iodide and benzene were prepared. A magnetic material in a part which was not covered with a mask was removed, by alternately immersing samples which have passed through the above described steps (1) and (2), into the two etching solutions (A) and (B). It is possible to remove one part or all parts of the magnetic material by controlling an etching period of time.

A resist was removed, and then the surface structure of the sample was observed with an electron microscope. As a result, it was clear that the magnetic material of the portion which was not covered with the mask was removed, while the magnetic material under a mask was not affected by the above described step (3).

The structure prepared by the method showed the structure as is shown in FIGS. 2A and 2B, in which a magnetic material is such a columnar shape as to penetrate the structure in a film thickness direction. This means that it becomes possible to make a lower layer exert an effect on the structure. For instance, it is conceivable to use a lower layer having a crystal plane exposed to the surface, in order to improve the orientation of the magnetic material. Thereby, it becomes possible to provide a magnetic recording medium with more satisfactory magnetic properties than a conventional one.

Specifically, the magnetic recording medium with the following configuration can be provided.

First, it is a magnetic recording medium provided with a plurality of recording regions, and separation regions which magnetically separate the adjacent recording regions from each other. The magnetic recording medium is composed of a plurality of first regions which are the recording regions having a columnar structure formed of a magnetic material, and a plurality of second regions which separate the first regions and are made of a non-magnetic material. Furthermore, the separation region is composed of a third region which has a plurality of columnar pores and is made of the non-magnetic material, and the columnar structure penetrates the recording region in a thickness direction.

Such a configuration makes it possible to provide an unprecedented magnetic recording medium.

### EXAMPLE 2

A second embodiment according to the present invention will be described.

In the present embodiment, steps (1) and (2) are the same as in Example 1.

(3) Step of Removing Magnetic Material in Region in which Mask is Not Formed or Transforming Magnetic Property

A magnetic material in a portion which was not covered with a mask was removed, by preparing an etching solution (C) which contains hydrogen peroxide water added to an aqueous solution of H₂SO₄ having a pH of 1.5, and alternately immersing samples which has passed through the above described steps (1) and (2), into the etching solutions (B) and (C) . It is possible to remove one part or all parts of the magnetic material by controlling an etching period of time.

A resist was removed, and then the surface structure of the sample was observed with an electron microscope. As a result, it was clear that the magnetic material of the portion which was not covered with the mask was removed, while the magnetic material under a mask was not affected by the above described step (3).

### EXAMPLE 3

A third embodiment according to the present invention will be described.

In the present embodiment, steps (1) and (2) are the same as in Example 1.

(3) Step of Removing Magnetic Material in Region in which Mask is Not Formed or Transforming Magnetic Property

An aqueous solution of H₂SO₄ (D) having a pH of 1.5 was prepared. Samples which have passed through steps (1) and (2) were electrolyzed in an aqueous solution (D) of an electrolyte so that the samples could become an anode. A magnetic material in a portion which was not covered with a mask was removed, by repeating the electrolytic etching step and a step of immersing the sample into an etching solution (B). It is possible to remove one part or the all parts of the magnetic material by controlling an etching period of time.

A resist was removed, and then the surface structure of the sample was observed with an electron microscope. As a result, it was clear that the magnetic material of the portion which was not covered with the mask was removed, while the magnetic material under a mask was not affected by the above described step (3).

### EXAMPLE 4

A fourth embodiment according to the present invention will be described.

In the present embodiment, steps (1) and (2) are the same as in Example 1.

(3) Step of Removing Magnetic Material in Region in which Mask is Not Formed or Transforming Magnetic Property

A CF₄ gas of 20 sccm was introduced into a chamber provided with an inductive coupled plasma (ICP) apparatus capable of generating plasma. A coil RF for generating plasma was set at 300 W and a platen RF in a substrate side was set at 0 W. When CF₄ is introduced into plasma, a radical F with a high degree of reactivity is formed therefrom. Samples which have passed through steps (1) and (2) were charged into such an environment, and were exposed to a reactive gas for 30 seconds. At this time, by setting the substrate side at 0 W, it became possible to minimize physical shock to the substrate, and to prevent Sio₂ surrounding a magnetic material from being etched by the physical shock due to the transformation of the magnetic material.

A resist was removed, and then samples of a part exposed to the reactive gas and a part which is not exposed to the reactive gas were observed with an MFM (magnetic force microscope) . As a result, such an MFM image as to appear when magnetization disappeared was obtained in the part having exposed to the gas.

### Comparative Example 1

A comparative example was prepared by the steps shown below.

(1) Step of Preparing Magnetic Recording Layer

A CoCrPt continuous medium with a film thickness of 20 nm was prepared by using only a CoCrPt magnetic material target in a magnetron sputtering apparatus.

In the present comparative example, a resist mask was formed by the same step (2) as in Example 1. Furthermore, the comparative example was subjected to the same step (3) as in Examples 1 to 4.

A resist was removed, and a cross section was observed through a TEM image. As a result, in a sample which has passed through an etching step, an obviously eroded state of CoCrPt was observed in a portion which has been covered with a mask. In addition, a border of a portion which was exposed to the reactive gas and a portion which was not exposed to the reactive gas in the sample was observed with an MFM (magnetic force microscope) . As a result, an MFM image did not show a distinct difference between the portion which was exposed to the gas and the portion which was not exposed to the gas, and it was found that a magnetic material in a masked portion was obviously degraded.

### EXAMPLE 5

A fifth embodiment according to the present invention will be described.

(1) Step of Preparing Structure Having Magnetic Material of Columnar Structure Separated by Mon-magnetic Material

Sequential deposition is made of Ru of 30 nm as a substrate electrode layer, and then an AlSi structure of 50 nm by sputtering a target with the composition of Al₅₆Si₄₄. It is a feature of the AlSi structure used here to be formed of a circular columnar aluminum portion and a Si portion surrounding it. The aluminum portion of the AlSi structure was removed by immersing into 2.8 mol % ammonia water at room temperature for 10 minutes, to form fine pores. Then, the pores acquired an average diameter of 8 nm and the average distance between the pores of 10 nm. The pores were filled with the magnetic material of FePt with an electroplating technique. As a result of having confirmed the composition of FePt with fluorescent X-rays analysis, the composition included 50 atom % Fe. As a result of having removed FePt which had overflowed outside the pores by polishing the plated surface, and observed a TEM image of the cross section and the surface of the sample, it was confirmed that the structure had the magnetic material of FePt with a columnar structure completely separated by the non-magnetic material of SiO₂.

In the present embodiment, a step (2) is the same as in Example 1. Furthermore, the example was subjected to the same step (3) as in Examples 1 to 4.

A structure prepared through the above described steps showed the same result as in Examples 1 to 4.

Specifically, it is understood that the present invention can prepare a desired pattern without degrading magnetic properties in a recording portion, and accordingly can form a discrete track structure and an arbitrary servo pattern.

The present invention can be applied to such a discrete track medium that requires magnetic recording of high density.

This application claims priority from Japanese Patent Application No. 2005-108667 filed Apr. 5, 2005, which is hereby incorporated by reference herein.

What is claimed is:

1. A method for producing a magnetic recording medium comprising:
a first step of preparing a structure having a plurality of first regions with a columnar structure made of a magnetic material separated by second regions made of a non-magnetic material;
a second step of forming a mask on a part to be a recording region in the structure; and
a third step of removing the magnetic material in a plurality of the first regions in the regions on which the mask is not formed, in the structure, or transforming magnetic properties of the magnetic material.

2. The method for producing a magnetic recording medium according to claim 1, wherein in the third step, the magnetic material is removed or the magnetic properties of the magnetic material are transformed by exposing the structure to a reactive gas or a reactive solution.

3. The method for producing a magnetic recording medium according to claim 1, wherein the magnetic material is CoCrPt and the non-magnetic material is SiO₂.

4. A magnetic recording medium provided with a plurality of recording regions, and separation regions which magnetically separate the adjacent recording regions, wherein
the recording region is composed of a plurality of first regions with a columnar structure made of a magnetic material, and a plurality of second regions which separate the first regions and are made of a non-magnetic material,
the separation region is composed of a third region which has a plurality of columnar pores and is made of the non-magnetic material, and
the columnar structure penetrates the recording region in the thickness direction.

5. The magnetic recording medium according to claim 4, wherein the magnetic material is CoCrPt and the non-magnetic material is SiO₂.
